(19) United States
(12) Patent Application Publication
(10) Pub. No.: US 2011/0234617 A1
(43) Pub. Date: Sep. 29, 2011

(54) MOBILE ELECTRONIC DEVICE

(75) Inventor: Tooma WATANABE, Osaka (JP)

(73) Assignee: KYOCERA CORPORATION, Kyoto (JP)

(21) Appl. No.: 13/071,344

(22) Filed: Mar. 24, 2011

(30) Foreign Application Priority Data
Mar. 25, 2010 (JP) 2010-069795

(51) Int. Cl. G06F 3/041; G09G 5/02

(52) U.S. Cl. 345/589

(57) ABSTRACT

A mobile electronic device is disclosed. A first display module comprises a first touch panel, and a second display module comprises a second touch panel. A battery supplies power to the first display module and the second display module, and a detection module determines whether the first touch panel and the second touch panel are viewable by a user. A setting module sets the first touch panel to a first brightness, if the battery level is below the first value and if the second touch panel is not viewable (non-viewable) by the user. The setting module sets the first touch panel and the second touch panel to a second brightness darker than the first brightness, if the battery level is below the first value and if the second touch panel is viewable by the user.

### CROSS-REFERENCE TO RELATED APPLICATION

The present application claims priority under 35 U.S.C. §119 to Japanese Patent Application No. 2010-069795, filed on Mar. 25, 2010, entitled “MOBILE TERMINAL DEVICE”. The content of which is incorporated by reference herein in its entirety.

### FIELD

Embodiments of the present disclosure relate generally to mobile electronic devices, and more particularly relate to a mobile electronic device comprising a plurality of display screens thereon.

### BACKGROUND

A mobile terminal device such as a flip mobile phone device may comprise two housings, and in some cases, each of the housings comprises a display screen such as a touch panel. In a mobile phone device comprising a plurality of display screens, electrical power consumption may increase in proportion to a number of the display screens. As a result, an operating time of a mobile terminal device comprising multiple display screens may be shorter than that of a mobile terminal device comprising a single display screen.

### SUMMARY

A mobile terminal device is disclosed. A first display module comprises a first touch panel, and a second display module comprises a second touch panel. A battery supplies power to the first display module and the second display module, and a detection module determines whether the first touch panel and the second touch panel are viewable by a user. A setting module sets the first touch panel to a first brightness, if a battery charge level falls below a first value and if the second touch panel is not viewable (non-viewable) by a user. The setting module sets the first touch panel and the second touch panel to a second brightness darker than the first brightness, if the battery level falls below the first value and if the second touch panel is viewable by the user.

In an embodiment, a first display module comprises a first touch panel and a second display module comprises a second touch panel. A battery supplies power to the first display module and the second display module, and a detection module determines whether the first touch panel and the second touch panel are viewable by a user. A setting module sets the first touch panel to a first brightness, if a battery charge level falls below a first value and if the second touch panel is not viewable (non-viewable) by a user. The setting module sets the first touch panel and the second touch panel to a second brightness darker than the first brightness, if the battery level falls below the first value and if the second touch panel is viewable by the user.

In another embodiment, a method for operating a mobile electronic device sets a first touch panel to a first brightness, if the battery level falls below a first value and a second touch panel is not viewable (non-viewable) by a user. The method further sets the first touch panel and the second touch panel to a second brightness darker than the first brightness, if the battery level falls below the first value and the second touch panel is viewable by the user.

### BRIEF DESCRIPTION OF THE DRAWINGS

Embodiments of the present disclosure are hereinafter described in conjunction with the following figures, wherein like numerals denote like elements. The figures are provided for illustration and depict exemplary embodiments of the present disclosure. The figures are provided to facilitate understanding of the present disclosure without limiting the breadth, scope, scale, or applicability of the present disclosure. The drawings are not necessarily made to scale.

FIG. 1A is an illustration of an exemplary external view of a mobile electronic device in a closed state according to an embodiment of the disclosure.

FIG. 1B is an illustration of an exemplary external view of a mobile electronic device in an open state according to an embodiment of the disclosure.

FIG. 2 is an illustration of an exemplary schematic functional block diagram of a mobile electronic device according to an embodiment of the disclosure.

FIG. 3 is an illustration of an exemplary table stored in a mobile electronic device according to an embodiment of the disclosure.

FIG. 4A is an illustration of an exemplary bright level of a back light of a touch panel of a mobile device in an open state according to an embodiment of the disclosure.

FIG. 4B is an illustration of an exemplary bright level of a back light of a touch panel of a mobile electronic device in an open state according to an embodiment of the disclosure.

FIG. 5 is an illustration of an exemplary flowchart showing a control process of a mobile electronic device according to an embodiment of the disclosure.

FIG. 6 is an illustration of an exemplary flowchart showing a display brightness control process of a mobile electronic device according to an embodiment of the disclosure.

FIG. 7A is an illustration of an exemplary display touch panel of a mobile electronic device in a close state according to an embodiment of the disclosure.

FIG. 7B is an illustration of an exemplary display touch panel of a mobile electronic device in an open state according to an embodiment of the disclosure.

FIG. 8 is an illustration of a schematic functional block diagram of a controller comprising an application-execution determination module according to an embodiment of the disclosure.

### DETAILED DESCRIPTION

The following description is presented to enable a person of ordinary skill in the art to make and use the embodiments of the disclosure. The following detailed description is exemplary in nature and is not intended to limit the disclosure or the application and uses of the embodiments of the disclosure. Descriptions of specific devices, techniques, and applications are provided only as examples. Modifications to the examples described herein will be readily apparent to those of ordinary skill in the art, and the general principles defined herein may be applied to other examples and applications without departing from the spirit and scope of the disclosure. The present disclosure should be accorded scope consistent with the claims, and not limited to the examples described and shown herein.

Embodiments of the disclosure are described herein in the context of one practical non-limiting application, namely, a mobile electronic device or a mobile electronic device such as a mobile phone. Embodiments of the disclosure, however, are not limited to such mobile phone, and the techniques described herein may be utilized in other applications. For example, embodiments may be applicable to digital books, digital cameras, electronic game machines, digital music players, personal digital assistance (PDA), personal handy phone system (PHS), lap top computers, Televisions (TV's), Global Positioning Systems (GPS's) or navigation systems, pedometers, health equipments, display monitors, and the like.

As would be apparent to one of ordinary skill in the art after reading this description, these are merely examples and the embodiments of the disclosure are not limited to operating in accordance with these examples. Other embodiments may be utilized and structural changes may be made without departing from the scope of the exemplary embodiments of the present disclosure.

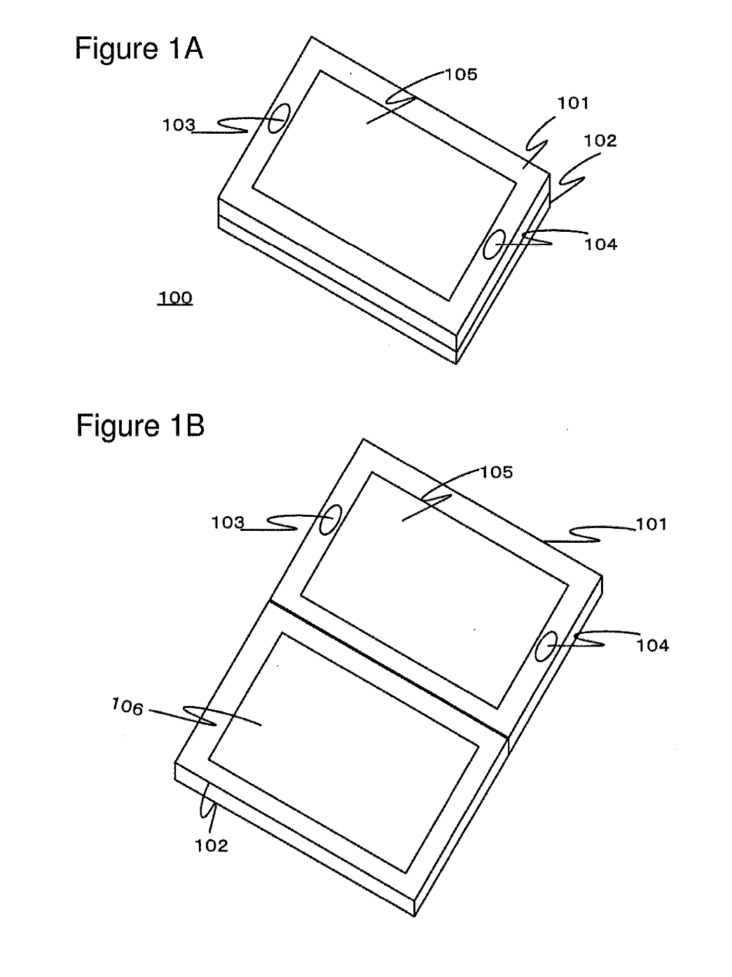

FIG. 1A is an exemplary external perspective view showing the closed state of the mobile phone 100 according to an embodiment of the disclosure. The mobile phone may comprise a flip-type mobile phone or rotating-type mobile phone as well as a sliding-type mobile phone described in the present embodiment. In addition, a strait-type mobile phone with two or more touch panels can be used. The mobile phone may comprise a plurality of touch panels, and a brightness of the back light of each touch panel may be controlled according to a battery voltage and opening/closing operations of a sliding mobile phone. The mobile phone 100 may comprise an upper housing 101 and a lower housing 102. In the closed state, the relative positions of the upper housing 101 and the lower housing 102 are such that the upper housing 101 covers a second touch panel 106. In the closed state one of the first touch panel 105 and the second touch panel 106 may not be viewable by the user.

FIG. 1B is an external perspective view showing the open state of the mobile phone 100 according to an embodiment of the disclosure. In the open state, the relative positions of the upper housing 101 and the lower housing 102 are such that a first touch panel 105 and the second touch panel 106 are viewable from a single direction relative to a user.

The upper housing 101 and the lower housing 102 are coupled in a manner allowing for opening and closing thereof. The upper housing 101 may comprise a speaker 103, a microphone 104, and a capacitive touch panel 105 (first touch panel 105). The lower housing 102 may comprise the capacitive touch panel 106 (second touch panel 106). Each touch panel can display a group of keys, such as a cursor keys or number keys, icons or the like. The user can perform various operations by touching/activating the group of keys with their finger and the like.

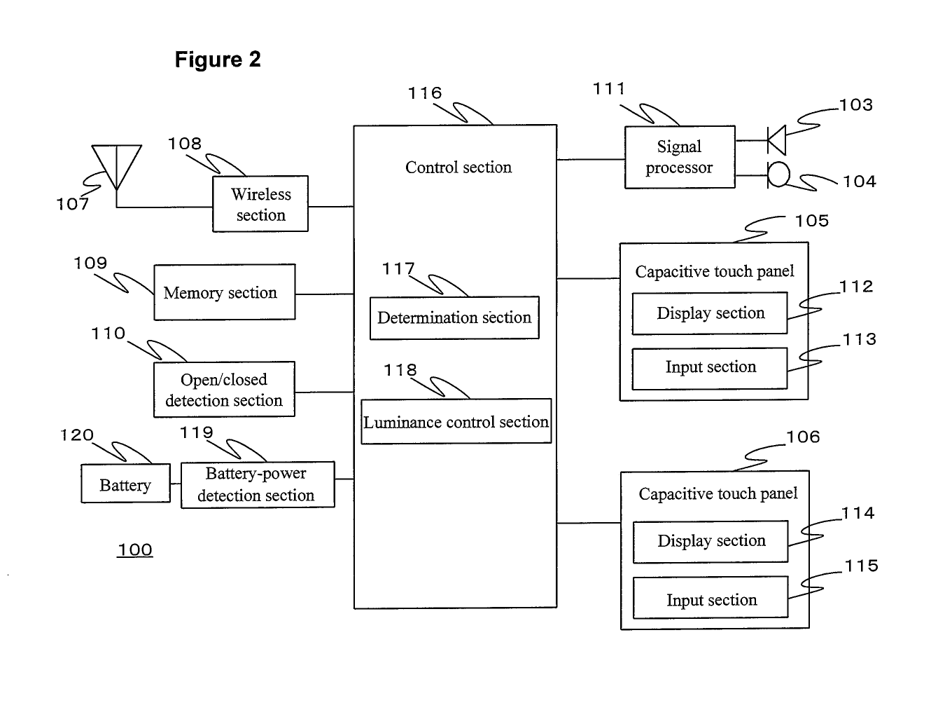

FIG. 2 is an illustration of an exemplary schematic functional block diagram of a mobile phone 100 (system 100) according to an embodiment of the disclosure. The mobile phone 100 comprises a wireless module 108, the microphone 104, the speaker 103, a signal processor 111, a position detection module 110, the first touch panel 105, the second touch panel 106, a memory module 109, a control module 116, a battery-power detection module 119, and a battery 120.

The wireless module 108 performs modulation and demodulation of signals sent from and received by an antenna 107 respectively.

The signal processor 111 performs processes for sending audio signals input from the microphone 104 via the wireless module 108, and processes for outputting audio signals received via the wireless module 108 from the antenna 107 to the speaker 103.

The microphone 104 outputs input audio to the signal processor 111 as audio signals.

The speaker 103 outputs audio signals output from the signal processor 111 as audio.

The first touch panel 105 comprises a display module 112 and an input module 113. The second touch panel 106 comprises a display module 114 and an input module 115.

The display module 112 and the display module 114 may be formed by, for example but without limitation, an organic electro-luminescence (OEL) panel, liquid crystal panel (LCD), and the like. Based on instructions from the control module 116, display module 112 and the display module 114 can display images of characters, icons and the like on, for example, the LCD. Based on instructions from a luminance setting module 118 the display module 112 or the display module 114 set a brightness of a back light of the LCD as described in more detail below. In this document, the brightness of the back light of the LCD is hereinafter also referred to as the brightness of the back light of the touch panel.

The input module 113 and the input module 115 detect user touch operations based on changes in capacitance of the touch panel 105 and the touch panel 106 respectively. The input module 113 and the input module 115 output detected coordinate values (X, Y) to the control module 116. In this manner, the input module 113 and/or the input module 115 calculate a value of an electric charge at each coordinate value. If the value of the electric charge exceeds a prescribed value, the input module 113 and/or the input module 115 determine that the user has pressed one of the first touch panel 105 and second touch panel 106. The input module 113 and the input module 115 define the coordinate values as where the value of the electrical charge exceeded the prescribed value (i.e., a position touched/pressed by the user on the touch panel) as the position is touched by the user and output the position to the control module 116. While the user touch operation is being detected by the input module 113 or the input module 115, the coordinate values (X, Y) of the position touched by the user are output to the control module 116 per unit time (e.g., 15 microseconds). If the electrical charge at a touched/activated position reaches below a prescribed value, the input module 113 and the input module 115 determine that the user has stopped pressing/touching the first touch panel 105 and the second touch panel 106. The input module 113 and the input module 115 define the coordinate values where the value of the electrical charge is below the prescribed value (i.e., the position that the user stopped pressing/touching) as the detached position and output the position to the control module 116.

The memory module 109 may be any suitable data storage area with suitable amount of memory that is formatted to support the operation of the system 100. Memory module 109 is configured to store, maintain, and provide data as needed to support the functionality of the system 100 in the manner described below. In practical embodiments, the memory module 109 may comprise, for example but without limitation, a non-volatile storage device (non-volatile semiconductor memory, hard disk device, optical disk device, and the like), a random access storage device (for example, SRAM, DRAM), or any other form of storage medium known in the art. The memory module 109 may be coupled to the control module 116 and configured to store, for example but without limitation, the input parameter values and the output parameter values corresponding to the a risk assessment scenario.

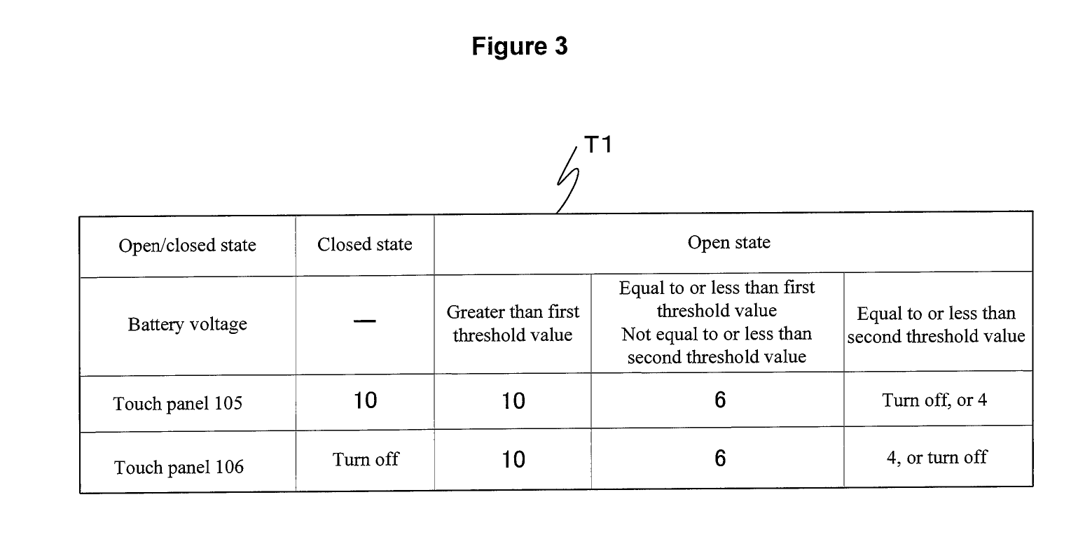

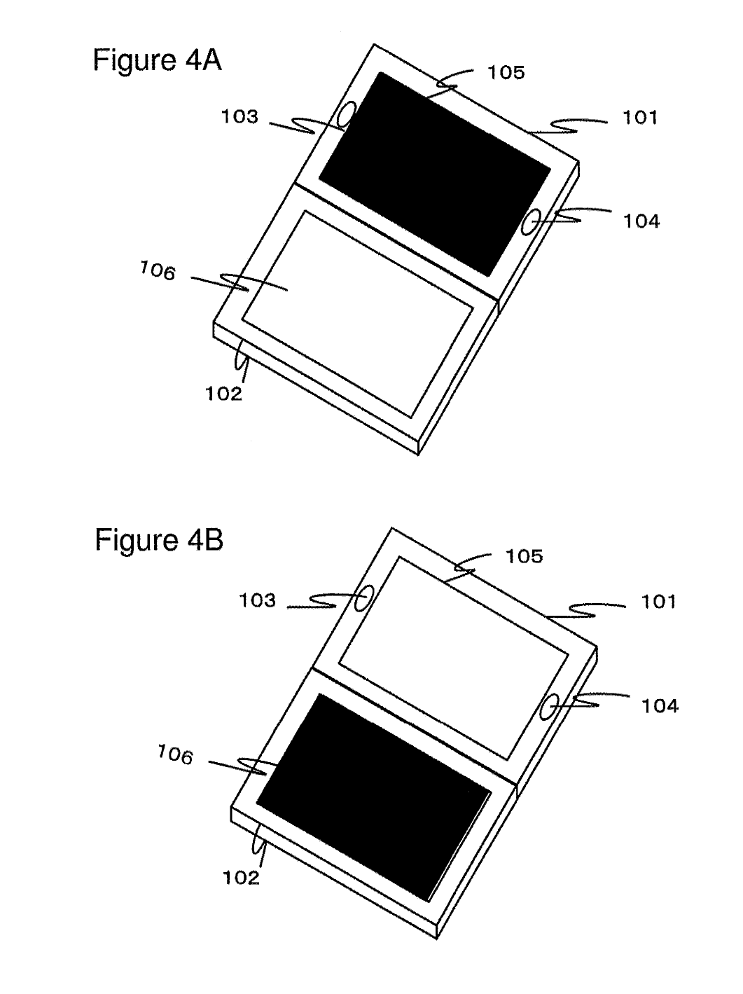

The memory module 109 may store, for example but without limitation, programs and the like processed by the control module 116. Moreover, while the input module 113 or the input module 115 is detecting a user touch operation, the memory module 109 may store coordinate values output from the input module 113 and the input module 115 per unit time (e.g., 15 microseconds). The memory module 109 may also store set values for the brightness of the back lights for the display module 112 and the display module 114 as explained in more detail in the context of discussion of FIGS. 3-4.

The memory module 109 may be coupled to the control module 116 that can read information from and write information to memory module 109. As an example, the control module 116 and memory module 109 may reside in their respective ASICs. The memory module 109 may also be integrated into the control module 116. In an embodiment, the memory module 109 may comprise a cache memory for storing temporary variables or other intermediate information during execution of instructions to be executed by the control module 116.

The position detection module 110 (detector module) to determines whether the first touch panel 105 and the second touch panel 106 are viewable by a user. In this manner, the position detection module 110 detects the relative position of the upper housing 101 relative to the lower housing 102. The position detection module 110 detects whether the mobile phone 100 is in the open state or the closed state. As mentioned above, in the open state the first touch panel 105 and the second touch panel 106 are viewable by the user, and in the close state one of the first touch panel 105 and the second touch panel 106 may non-viewable by the user. The position detection module 110 outputs the detected result to the control module 116. The position detection module 110 may comprise a magnetic sensor in each of the upper housing 101 and the lower housing 102, for example. When the mobile phone 100 is in the closed state, an electrical signal is transmitted when the respective magnetic sensors become adjacent to one another, and when the mobile phone 100 is in the open state, no electrical signal is transmitted because the magnetic sensors are separated.

The battery-power detection module 119 detects the voltage of the battery 120. Alternatively, the battery-power detection module 119 can detect a current of the battery 120, a power of the battery 120 and the like. The battery-power detection module 119 outputs, for example but without limitation, a detected voltage, a detected current or a detected power of the battery 120 to the determination module 117. The battery-power detection module 119 may comprise any type as long as it detects the battery power of the battery 120.

The control module 116 can control the overall operations of the mobile phone 100. The control module 116 is configured to support functions of the system 100. The control module 116 may control operations of the system 100 so that processes of the system 100 are suitably performed. For example, the control module 116 comprises and control operations of the luminance setting module 118 and the determination module 117. The control module 116 also controls the touch panel 105 and the touch panel 106 to display input/output parameters, and the like. Further, the control module 116 accesses the memory module 109 such as access to the table T1 as explained below, such that the luminance setting module 118 sets brightness values of the touch panel 105 and the touch panel 106.

The control module 116, may be implemented or realized with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

The determination module 117 compares the voltage of the battery 120 detected by the battery-power detection module 119 with a threshold value. The determination module 117 outputs the detected result to the luminance setting module 118.

The luminance setting module 118 sets the brightness of the back lights of the first touch panel 105 and the second touch panel 106. In this manner, the luminance setting module 118 sets the first touch panel 105 to a first brightness if a battery voltage of the battery 120 is below the first value and if the second touch panel 106 is not viewable (non-viewable) by the user, and sets the first touch panel 105 and the second touch panel 106 to a second brightness darker than the first brightness if the battery voltage is below the first value and if the second touch panel is viewable by the user.

If a touch operation by the user is detected by the input module 113 or the input module 115, based on the output from the position detection module 110 and the output from the determination module 117, the luminance setting module 118 refers to the table T1 stored in the memory module 109. In this manner, the luminance setting module 118 sets the brightness of the back lights of the first touch panel 105 and the second touch panel 106 based on the table T1.

FIG. 3 is an illustration of an exemplary table T1 stored in the memory module 109 of the mobile phone 100 according to an embodiment of the disclosure sets values necessary for setting the brightness of the back lights of the touch panels when the mobile phone 100 is in an open state or in a closed state are stored in the table T1 according to the voltage of the battery 120. In one embodiment, the brightness of the back light can be set in 11 stages from 0 to 10. At the set value “0”, the back light is turned off. At the set value “1”, the back light emits light at the lowest level. As the set value increases, the back light becomes brighter.

At the set value “10”, the back light emits light at the highest level. In the table T1, if the mobile phone 100 is in the closed state, the brightness of the first touch panel 105 is set to the set value “10” regardless of the voltage of the battery 120. In the open state, the set value for the first touch panel 105 differs according to the voltage of the battery 120.

FIGS. 4A and 4B show the brightness of the back lights of the first touch panel 105 and the second touch panel 106 in the open state when the voltage of the battery 120 is equal to or less than a second threshold value. In FIG. 4A, the brightness of the second touch panel 106 is set to the set value “4”, and the brightness of the first touch panel 105 is set to the set value “0”. At the same time, in FIG. 4B, the brightness of the first touch panel 105 is set to the set value “4”, and the back light of the second touch panel 106 is set to the set value “0”.

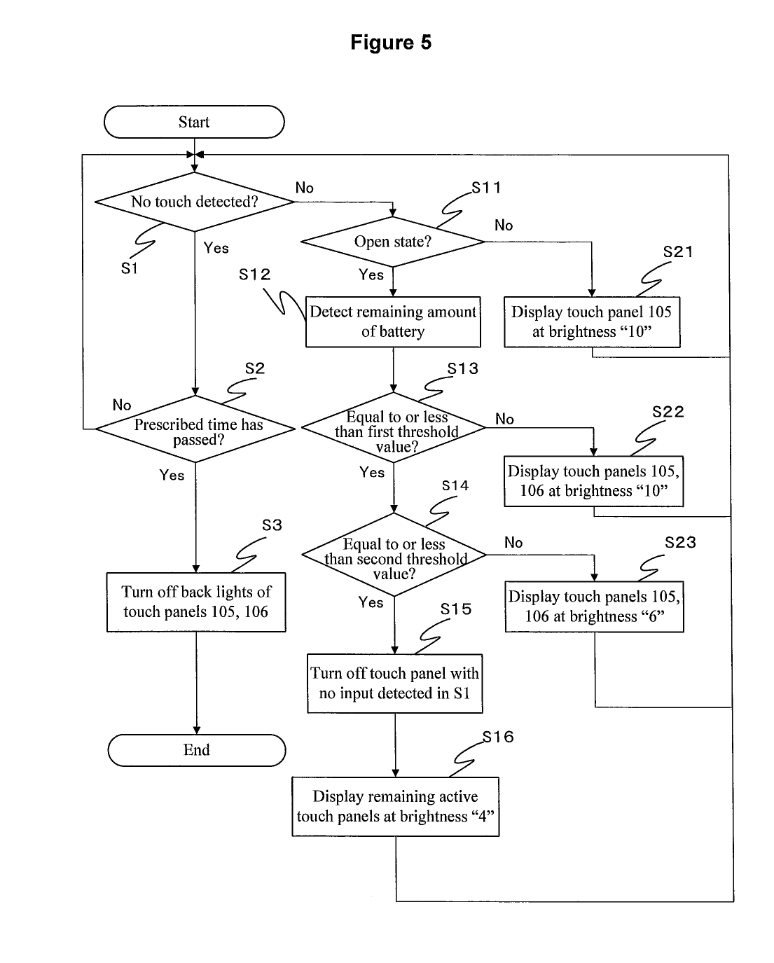

FIG. 5 is an illustration of an exemplary flowchart showing a control process 500 of the mobile phone 100 according to an embodiment of the disclosure. The various tasks performed in connection with process 500 may be performed, by software, hardware, firmware, a computer-readable medium having computer executable instructions for performing the process method, or any combination thereof. The process 500 may be recorded in a computer-readable medium such as a semiconductor memory, a magnetic disk, an optical disk, and the like, and can be accessed and executed, for example, by a computer CPU such as the control module 116 in which the computer-readable medium is stored.

It should be appreciated that process 500 may include any number of additional or alternative tasks, the tasks shown in FIG. 5 need not be performed in the illustrated order, and process 500 may be incorporated into a more comprehensive procedure or process having additional functionality not described in detail herein. For illustrative purposes, the following description of process 500 may refer to elements mentioned above in connection with FIGS. 1-4.

In practical embodiments, portions of the process 500 may be performed by different elements of the mobile phone 100 such as: the wireless module 108, the microphone 104, the speaker 103, the signal processor 111, the position detection module 110, the first touch panel 105, the second touch panel 106, the memory module 109, the control module 116, the battery-power detection module 119, the battery 120, etc. Process 600 may have functions, material, and structures that are similar to the embodiments shown in the FIGS. 1-3. Therefore common features, functions, and elements may not be redundantly described here.

First, the input module 113 and the input module 115 detect a user touch operation (inquiry task S1). User touch operations are detected by the first touch panel 105 in the closed state and by the first touch panel 105 or the second touch panel 106 in the open state.

When neither the first touch panel 105 nor the second touch panel 106 detects a user touch operation (“YES” branch of inquiry task S1), the control module 116 determines whether a prescribed amount of time has passed (inquiry task S2). If the control module 116 determines that a prescribed amount of time has passed (“YES” branch of inquiry task S2), the luminance setting module 118 causes the back lights of the first touch panel 105 and the second touch panel 106 to be turned off (task S3).

When the first touch panel 105 or the second touch panel 106 detects a user touch operation (“NO” branch of inquiry task S1), the position detection module 110 detects whether the mobile phone 100 is in the open state or not (inquiry task S11). If the mobile phone 100 is not in the open state (“NO” branch of inquiry task S11), the luminance setting module 118 controls the brightness of the back light of the first touch panel 105 based on the table T1. Specifically, the luminance setting module 118 sets the brightness of the back light of the first touch panel 105 to the brightness of the set value “10” (task S21).

If the mobile phone 100 is in the open state (“YES” branch of inquiry task S11), the battery-power detection module 119 detects the voltage of the battery 120 (task S12). The determination module 117 determines whether or not the voltage of the battery 120 detected by the battery-power detection module 119 is equal to or less than a first threshold value stored in the memory module 109 (inquiry task S13). If the detected voltage of the battery 120 is not equal to or less than the first threshold value (“NO” branch of inquiry task S13), the luminance setting module 118 controls the brightness of the back lights of the first touch panel 105 and the second touch panel 106 based on the table T1. Specifically, the luminance setting module 118 sets the brightness of the back lights of the first touch panel 105 and the second touch panel 106 to the brightness of the set value “10” (task S22).

If the voltage of the battery 120 is equal to or less than the first threshold value (“YES” branch of inquiry task S13), the determination module 117 determines whether the voltage of the battery 120 is equal to or less than the second threshold value (inquiry task S14). If the voltage of the battery 120 is not equal to or less than the second threshold value (“NO” branch of inquiry task S14), the luminance setting module 118 sets the brightness of the back lights of the first touch panel 105 and the second touch panel 106 to the brightness of the set value “6” (task S23). After the process of task S23, the process 500 leads back to the task S1. If the voltage of the battery 120 is equal to or less than the first threshold value (“YES” branch of inquiry task S13) and is not equal to or less than the second threshold value (“NO” branch of inquiry task S14), the brightness of the first touch panel 105 and the second touch panel 106 becomes darker than the brightness used when the voltage of the battery 120 exceeds the first threshold value. Consequently, if the voltage of the battery 120 becomes low (i.e., if the remaining amount of charge of the battery 120 becomes low), the brightness of the back light is lowered according to the number of touch panels being used, and therefore, consumption of the battery 120 can be suppressed.

If a touch operation is detected after the process of the task S23 (inquiry task S1), and if the mobile phone 100 is in the closed state (inquiry task S11), the luminance setting module 118 sets the brightness of the back light of the first touch panel 105 to the brightness of the set value “10”.

If the voltage of the battery 120 is equal to or less than the second threshold value (“YES” branch of inquiry task S14), the luminance setting module 118 sets the back light of one of either the first touch panel 105 or the second touch panel 106 to the brightness of the set value “0”, and sets the back light of the other touch panel to the brightness of the set value “4” (task S16). After the process of the task S16, the process 500 lead back to inquiry task S1.

In the task S15, the luminance setting module 118 turns off the back light of any touch panel in which no user touch operation was detected. Specifically, if, as a result of the inquiry task S1, no user touch operation is detected, the luminance setting module 118 turns off the back light of any touch panel in which no user touch operation is detected.

If, as a result of the inquiry task S1, for example, a user touch operation is detected in only the input module 113 from among the input module 113 and the input module 115, the luminance setting module 118 sets the back light of the second touch panel 106 to the brightness of the set value “0” (task S15) and sets the back light of the first touch panel 105 to the brightness of the set value “4” (task S16). In this case, the back light of the second touch panel 106 is turned off. If the back light of the second touch panel 106 is turned off, if the second touch panel 106 detects a touch operation (inquiry task S1), the luminance setting module 118 sets the back light of the second touch panel 106 to the brightness of the set value “4”. Then, the luminance setting module 118 sets the back light of the first touch panel 105 to the set value “0”.

After the task S16, if the mobile phone 100 is not in the open state (“NO” branch of inquiry task S11), the luminance setting module 118 can set the back light of the first touch panel 105 to the brightness of the set value “10”.

Based on the above operations, when using a plurality of touch panels, the brightness of the back light of each touch panel can be set according to the voltage of the battery.

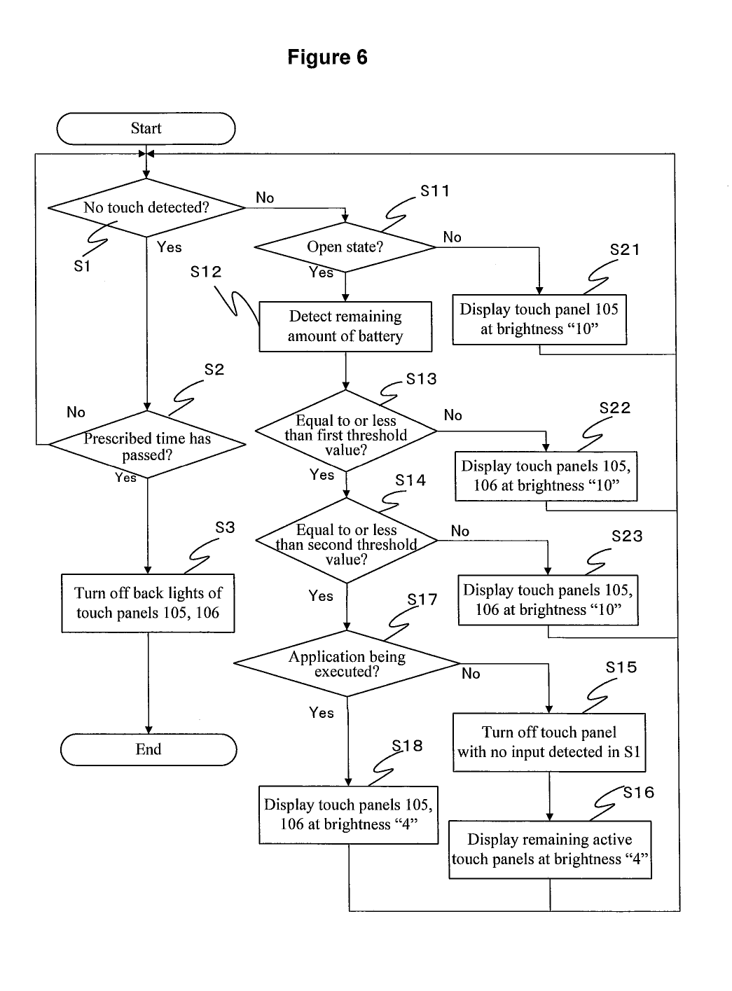

FIG. 6 is a flowchart showing the control processes 600 of the mobile phone 100 according to one embodiment. The various tasks performed in connection with process 600 may be performed, by software, hardware, firmware, a computer-readable medium having computer executable instructions for performing the process method, or any combination thereof. The process 600 may be recorded in a computer-readable medium such as a semiconductor memory, a magnetic disk, an optical disk, and the like, and can be accessed and executed, for example, by a computer CPU such as the control module 116 in which the computer-readable medium is stored.

It should be appreciated that process 600 may include any number of additional or alternative tasks, the tasks shown in FIG. 6 need not be performed in the illustrated order, and process 600 may be incorporated into a more comprehensive procedure or process having additional functionality not described in detail herein. For illustrative purposes, the following description of process 600 may refer to elements mentioned above in connection with FIGS. 1-5.

In practical embodiments, portions of the process 600 may be performed by different elements of the mobile phone 100 such as: the wireless module 108, the microphone 104, the speaker 103, the signal processor 111, the position detection module 110, the first touch panel 105, the second touch panel 106, the memory module 109, the control module 116, the battery-power detection module 119, the battery 120, etc. Process 600 may have functions, material, and structures that are similar to the embodiments shown in the process 600. Therefore common features, functions, and elements may not be redundantly described here.

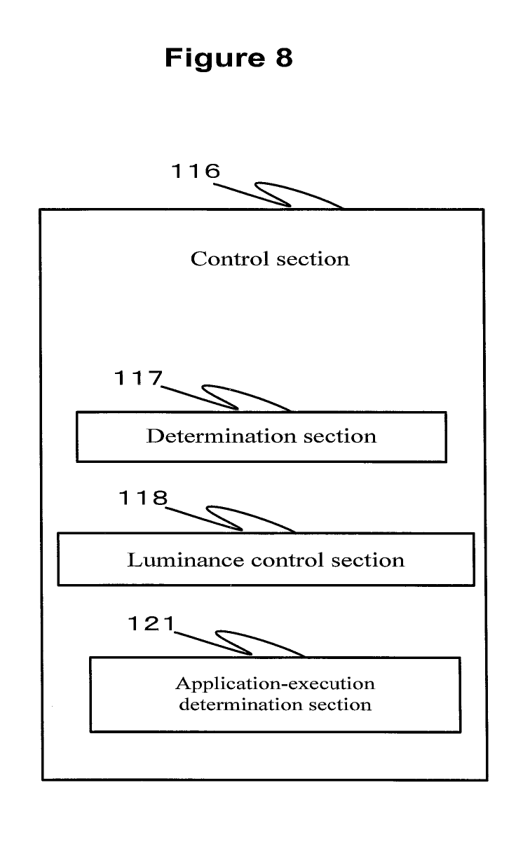

If a user is writing an email on the second touch panel 106, a received email may be displayed on the first touch panel 105. At this time, the back lights of both touch panels may be turned on. In other words, in one embodiment, when executing an application for writing an email and the like, the user may perform inputs on one touch panel (e.g., second touch panel 106) while referring to information displayed on the other touch panel (e.g., first touch panel 105). Therefore, during the execution of the application, the luminance setting module 118 need not turn off the back lights of the touch panels. For this purpose, the control module 116 may further comprise an application-execution determination module 121 that determines whether an application is being executed as explained in more detail in the context of discussion of FIG. 8.

In the inquiry task S14 of FIG. 5, if the voltage of the battery 120 is equal to or less than the second threshold value, the application-execution determination module determines whether an application is being executed (inquiry task S17). If an application is being executed (“YES” branch of inquiry task S17), the luminance setting module 118 sets the back lights of both the first touch panel 105 and the second touch panel 106 to the brightness of the set value “4” (task S18). If an application is not being executed (“NO” branch of inquiry task S17), the luminance setting module 118 proceeds to the task S15.

Based on the above operations, the brightness of the back light of each touch panel can be set according to the voltage of the battery 120 without diminishing convenience for the user. In the present disclosure, “applications” may be used to describe: applications for sending, receiving and writing emails, applications for navigating to a destination, applications for playing music files, applications for playing movie files, and applications for receiving and outputting digital terrestrial broadcasts and the like.

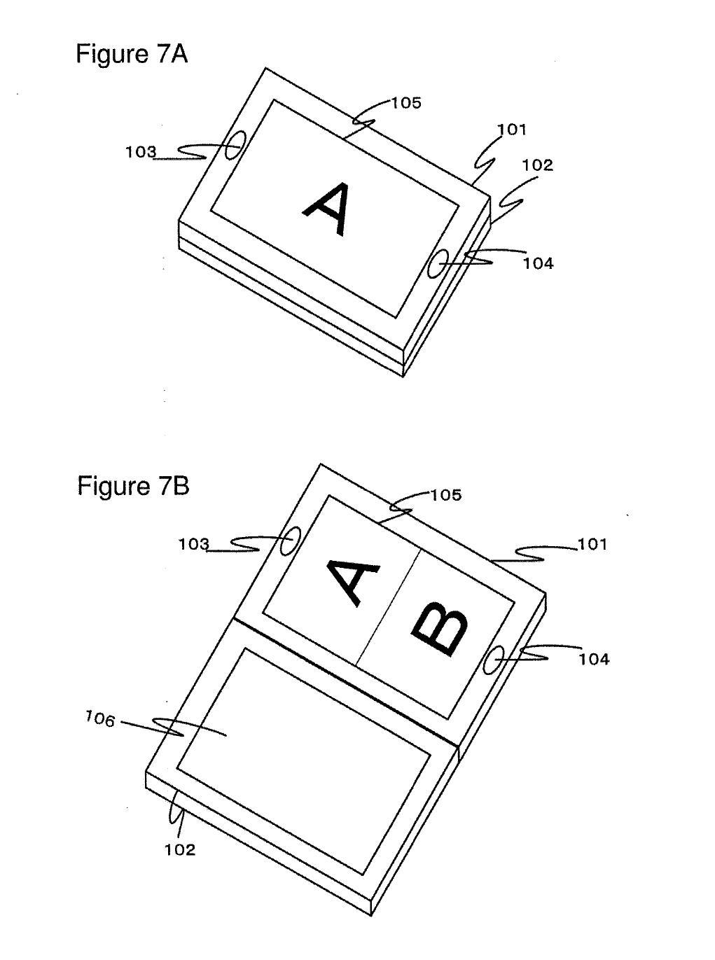

In the process of the task S15, if one touch panel is turned off, the other touch panel may display two screens. For example, as shown in FIG. 7A, if “A” is displayed on the first touch panel 105 in the closed state, when the second touch panel 106 is turned off as a result of the processes of the inquiry task S13, the inquiry task S14 and the task S15, the image “B” displayed on the second touch panel 106 may be displayed by dividing the touch panel of the first touch panel 105 as shown in FIG. 7B. As a result, it is possible to display two touch panels on a single screen/touch panel.

FIG. 8 is an illustration of a schematic functional block diagram of a control module 116 comprising the application-execution determination module 121 according to an embodiment of the disclosure. The control module 116 comprises the determination module 117, the luminance setting module 118, and the application-execution determination module 121. The application-execution determination module 121 determines whether an application is being executed.

In the above embodiment, two touch panels (first touch panel 105 and second touch panel 106) are used, but the number of touch panels is not limited to two. Three or more capacitive touch panels may be used. For example, in one embodiment, if three or more touch panels are used, and if the voltage of the battery 120 is equal to or less than the first threshold value and is not equal to or less than the second threshold value, the brightness of the back lights of the touch panels may be decreased as the number of capacitive touch panels being used increases. For example, in one embodiment, if one capacitive touch panel is used, the luminance setting module 118 may set the brightness of the back light of the touch panel being used to the brightness of the set value “10”, and if two capacitive touch panels are used, the brightness of the back lights of the touch panels being used may be set to the brightness of the set value “8”, and if three capacitive touch panels are used, the brightness of the touch panels being used may be set to the brightness of the set value “6”.

If three touch panels are used and the remaining battery is below the second threshold value, the luminance setting module 118 may turn off the touch panels other than a specific touch panel. The specific touch panel may be, for example, a touch panel on which a user touch operation has been detected.

In the above embodiment, the brightness of the back lights of the first touch panel 105 and the second touch panel 106 that is set in the process of the task S23 is set to a lower brightness compared to the brightness set in the process of the task S22, and subsequently, through S1, when the closed state is detected in the inquiry task S11, the brightness of the back light of the first touch panel 105 is set to the brightness of the set value “10”. Alternatively, if the closed state is detected in the inquiry task S11, the luminance setting module 118 may set the brightness of the back light of the first touch panel 105 to the brightness of the set value “6”, which is the same as that of the process of the task S22, instead of the brightness of the set value “10”.

In the above embodiment, after the task S16, if the closed state is detected in the inquiry task S11, the brightness of the back light of the first touch panel 105 is set to the brightness of the set value “10”. Alternatively, if the closed state is detected in the inquiry task S11, the luminance setting module 118 may set the back light of the first touch panel 105 to the brightness of the set value “4”, which is the same as that of the process of the task S16, instead of the brightness of the set value “10”.

In the above embodiment, touch panels are used, but alternatively, each display module and each input module may be different. Specifically, displays may be used for the display modules and operational keys may be used for the input modules. In this case, the luminance setting module 118 sets the brightness of the displays. In this case, the process of the task S15 may be performed according to which of the upper housing 101 or the lower housing 102 the operated operational key is provided on.

If the display module 112 and the display module 114 differ and the input module 113 and the input module 115 differ, the luminance setting module 118 may set the brightness of the display modules by determining which display module an input was made on. For example, if the input module provided on the lower housing 102 is used to perform inputs into the display module provided on the upper housing 101, the luminance setting module 118 may treat the inputs into the input module as inputs into the display module provided on the upper housing 101 and set the brightness of the display module provided on the upper housing 101.

In one embodiment, a maximum voltage of the battery 120 is about 4.5V, the first threshold value may be about 3V and the second threshold value may be about 1.5V.

The control module 116 may, for example, cause the first touch panel 105 or the second touch panel 106 to display an icon indicating the remaining battery of the battery 120. In this case, if the voltage of the battery 120 goes below the first threshold value, the control module 116 may change the display of the icon. If the voltage of the battery 120 goes below the second threshold value, the control module 116 may change the display of the icon.

In one embodiment, the luminance setting module 118 turns off the back light of one touch panel (i.e., turned-off touch panel) in the task S15 (FIG. 5). In this case, the brightness of the back light may be decreased in stages and finally turned off. Moreover, before the luminance setting module 118 causes the back light to turn off, the control module 116 may cause the first touch panel 105 or the second touch panel 106 to display an indication that the touch panel will be turned off. The luminance setting module 118 may turn off the touch panel after a prescribed amount of time has passed from the decision to turn off the touch panel in the task S15.

In one embodiment, in the task S23, the luminance setting module 118 sets the brightness of the back lights of the first touch panel 105 and the second touch panel 106 to the brightness of the set value “6”. Alternatively, for example, if a user touch operation is detected in the inquiry task S1 after the brightness to the back light is set to the brightness of the set value “6” in the task S23, the luminance setting module 118 may set the brightness of the touch panel on which the touch operation was detected to the brightness of the set value “8”, and set the brightness of the touch panel on which no input was detected to the brightness of the set value “4”. The luminance setting module 118 may make the brightness of the touch panel on which the touch operation was detected brighter, and make the brightness of the touch panel on which no input was detected darker.

In this manner, an electrical mobile device comprising a plurality of display screens comprising touch panels reduces electrical power used by the touch panels.

Terms and phrases used in this document, and variations hereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future.

Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the present disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent. The term “about” when referring to a numerical value or range is intended to encompass values resulting from experimental error that can occur when taking measurements.

1. A mobile electronic device, comprising:
a first display module comprising a first touch panel;
a second display module comprising a second touch panel;
a battery operable to supply power to the first display module and the second display module;
a detection module operable to determine whether the first touch panel and the second touch panel are viewable by a user; and
a setting module operable to set the first touch panel to a first brightness if a battery voltage of the battery is below the first value and if the second touch panel is not viewable by the user, and to set the first touch panel and the second touch panel to a second brightness darker than the first brightness if the battery voltage is below the first value and if the second touch panel is viewable by the user.

2. The mobile electronic device according to claim 1, further comprising a first housing and a second housing, wherein the first housing comprises the first display module and the second housing comprises the second display module.

3. The mobile electronic device according to claim 2, wherein the second display module is covered by the first housing.

4. The mobile electronic device according to claim 1, wherein the setting module is further operable to set the first display module to the first brightness, if the second display module becomes non-viewable by the user when both the first display module and the second display module are set to the second brightness.

5. The mobile electronic device according to claim 4, wherein the setting module is further operable to turn off at least one of the first display module and the second display module if the battery voltage is below a second value lower than the first value.

6. The mobile electronic device according to claim 4, further comprising an application-execution determination module operable to determine whether an application is being executed, wherein the setting module is further operable to keep turning on both the first touch panel and the second touch panel if an application is being executed and if the voltage is below a second level.

7. The mobile electronic device according to claim 4, wherein the setting module is further operable to set a screen of the first display module and the second display module that is not off to a third brightness darker than the second brightness, if one of the first display module and the second display module is turned off.

8. The mobile electronic device according to claim 4, wherein the setting module is further operable to set the first display module to the first brightness if the second display module becomes non-viewable by the user while one of the first display module and the second display module is turned off.

9. The mobile electronic device according to claim 4, wherein
the first touch panel comprises a first input module operable to detect user touch operations;
the second touch panel comprises a second input module operable to detect the user touch operations; and
the setting module is further operable to set a turned-off touch panel of the first touch panel and the second touch panel to a third brightness darker than the second brightness, if a user touch operation is detected on the turned-off touch panel.

10. A method for operating a mobile electronic device, comprising:
setting a first touch panel to a first brightness, if a battery voltage falls below a first value and a second touch panel is not viewable by a user; and
setting the first touch panel and the second touch panel to a second brightness darker than the first brightness, if the battery voltage falls below the first value and the second touch panel is viewable by the user.

11. The method according to claim 10, wherein a first housing comprises the first touch panel and the second housing comprises the second touch panel.

12. The method according to claim 11, wherein the second touch panel is covered by the first housing.

13. The method according to claim 10, further comprising setting the first touch panel to the first brightness, if the second touch panel becomes non-viewable by the user when both the first touch panel and the second touch panel are set to the second brightness.

14. The method according to claim 13, further comprising turning off at least one of the first touch panel and the second touch panel, if the battery voltage falls below a second value lower than the first value.

15. The method according to claim 13, further comprising keeping the first touch panel and the second touch panel on, if an application is being executed and the battery voltage is below a second level.

16. The method according to claim 13, further comprising setting a touch panel to a third brightness darker than the second brightness, if one of the first touch panel and the second touch panel is turned off.

17. The method according to claim 13, further comprising setting the first touch panel to the first brightness, if the second touch panel becomes non-viewable by the user while one of the first touch panel and the second touch panel is turned off.

18. The method according to claim 13, further comprising setting a turned-off touch panel of the first touch panel and the second touch panel to a third brightness darker than the second brightness, if a user touch operation is detected on the turned-off touch panel.
